(19) United States
(12) Patent Application Publication
(10) Pub. No.: US 2026/0231014 A1
(43) Pub. Date: Aug. 6, 2026

(54) SMART ADAPTIVE POWER SAVING FOR MULTIPLE TECHNOLOGY CREDENTIAL READER

(71) Applicant: ASSA ABLOY AB, STOCKHOLM (SE)

(72) Inventors: Greg Smith, Bridgend (GB); Stephen Wheatstone, Pontypridd (GB)

(21) Appl. No.: 19/143,517

(22) PCT Filed: Dec. 21, 2023
(86) PCT No.: PCT/EP2023/087490

§ 371 Date: Jun. 26, 2025

Related U.S. Application Data
(60) Provisional application No. 63/477,933, filed on Dec. 30, 2022.

(51) Int. Cl. H04W 52/02; H04W 8/00; H04W 12/06

(52) U.S. Cl. CPC H04W 52/0203; H04W 8/005; H04W 12/06

(57) ABSTRACT

A method and system for adaptive power saving for a multiple technology credential reader may provide improved credential reader power management. The multiple technology credential reader may poll for a first credential type using a first credential radio within the plurality of credential radios. The multiple technology credential reader may discover a first device associated with the first credential type within a radio frequency range of the first credential radio and may cause, responsive to discovering the first device, a second credential radio associated with a second credential type to enter a low power mode. The multiple technology credential reader may determine the first device is positioned within a close proximity threshold range of the multiple technology credential reader, and may authorize a credential access (e.g., physical access, logical access) for the first device responsive to determining the first device is positioned within the close proximity threshold range.

### PRIORITY APPLICATION

This application claims priority to U.S. Provisional Patent Application Ser. No. 63/477,933, filed on Dec. 30, 2022, the disclosure of which is incorporated by reference herein in its entirety.

### TECHNICAL FIELD

Embodiments described herein generally relate to power management of a reader device of access control system, and particularly to adaptive power management of access credentials devices.

### BACKGROUND

There are many applications for which access credentials devices are desirable. Some examples include physical and logical access control systems. Physical access control includes identification of authorized users or devices (e.g., vehicles, drones, etc.) and actuation of a gate, door, or other mechanism used to secure an area or actuation of a control mechanism, e.g., a physical or electronic/software control mechanism, permitting access to a secure physical asset, such as a computing device (e.g., desktop computer, mobile device, wearable electronic device, copier/printer, and the like). Logical access control includes identification of authorized users or devices to provide access to logical assets, such as an application, a cloud-based service, a financial or personal account, or another logical asset. A credential device, in general, may include any device that carries evidence of authority, status, rights, or entitlement to privileges for a holder of the credential device, including any portable device (such as a credential card, electronic key, mobile phone, etc.) having memory storing one or more user credentials or credential data. Non-limiting example credential devices include various credential devices offered by HID Global Corporation, based in Austin, Texas.

Access credentials devices may be based on diverse types of access technology. In some examples, physical access cards may use magnetic stripe credentials, radio frequency identification (RFID) credentials (e.g., low frequency (LF) 125 KHz credentials, high frequency (HF) 13.56 MHz credentials), or other wireless technologies. Physical access card adoption and use faces various problems, such as physical access cards becoming lost, and physical access cards being environmentally unfriendly to produce. To address problems facing lost or environmentally unfriendly physical access cards, additional technologies have been explored. These alternative access credential technologies may include biometric readers (e.g., fingerprint reader, facial recognition) or wireless radio devices such as mobile phones or wearable devices. Wireless radio devices may use one or more wireless radio technologies, such as Bluetooth (BT), Bluetooth Low Energy (BLE), Wi-Fi, Ultra-wideband (UWB), and other wireless radio technologies.

Access credentials devices may be expanded to include credential readers for multiple technologies. In an example, multiple technology access credentials devices may be equipped to communicate with an RFID card, a Wi-Fi phone, and a BLE wearable device. However, these multiple technology access credentials devices require additional power to support multiple access technologies. Thus, solutions are desirable that would enable improved power management and reduced power consumption for multiple technology access credentials devices.

### BRIEF SUMMARY

The following presents a simplified summary of one or more embodiments of the present disclosure to provide a basic understanding of such embodiments. This summary is not an extensive overview of all contemplated embodiments, and is intended to neither identify key or critical elements of all embodiments, nor delineate the scope of any or all embodiments.

In some aspects, the techniques described herein relate to a system for adaptive power saving for a multiple technology credential reader, the system including: a multiple technology credential reader including a plurality of credential radios, processing circuitry, and a memory that includes instructions, the instructions, when executed by the processing circuitry, cause the multiple technology credential reader to: poll for a first credential type using a first credential radio within the plurality of credential radios; discover a first device associated with the first credential type within a radio frequency range of the first credential radio; cause, responsive to discovering the first device, a second credential radio associated with a second credential type to enter a low power mode; determine the first device is positioned within a close proximity threshold range of the multiple technology credential reader; and authorize a physical access for the first device responsive to determining the first device is positioned within the close proximity threshold range.

In some aspects, the techniques described herein relate to a method for adaptive power saving for a multiple technology credential reader, the method including: polling for a first credential type using a first credential radio, the first credential radio among a plurality of credential radios coupled to a multiple technology credential reader; discovering a first device associated with the first credential type within a radio frequency range of the first credential radio; causing, responsive to discovering the first device, a second credential radio associated with a second credential type to enter a low power mode; determining the first device is positioned within a close proximity threshold range of the multiple technology credential reader; and authorizing a physical access for the first device responsive to determining the first device is positioned within the close proximity threshold range.

In some aspects, the techniques described herein relate to a method for adaptive power saving for a multiple technology credential reader, the method including: retrieving, at a multiple technology credential reader, a first polling countdown timer and a low power polling countdown timer from among a plurality of countdown timers stored in a memory of the multiple technology credential reader; determining the first polling countdown timer has not completed, the first polling countdown timer associated with a first credential type and a first credential radio coupled to the multiple technology credential reader; determining the low power polling countdown timer has completed, the low power polling countdown timer associated with a low power credential type and a low power credential radio; polling for the low power credential type using the low power credential radio; determining a low power device associated with the low power credential type is positioned within a close proximity threshold range of the multiple technology credential reader; and authorizing a physical access for the low power device responsive to determining the low power device is positioned within the close proximity threshold range.

In some aspects, the techniques described herein relate to a system for adaptive power saving for a multiple technology credential reader, the system including: a multiple technology credential reader including a plurality of credential radios, processing circuitry, and a memory that includes instructions, the instructions, when executed by the processing circuitry, cause the multiple technology credential reader to: retrieve a first polling countdown timer and a low power polling countdown timer from among a plurality of countdown timers stored in the memory; determine the first polling countdown timer has not completed, the first polling countdown timer associated with a first credential type and a first credential radio; determine the low power polling countdown timer has completed, the low power polling countdown timer associated with a low power credential type and a low power credential radio; poll for the low power credential type using the low power credential radio; determine a low power device associated with the low power credential type is positioned within a close proximity threshold range of the multiple technology credential reader; and authorize a physical access for the low power device responsive to determining the low power device is positioned within the close proximity threshold range.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the scope of the present disclosure.

Accordingly, the drawings and detailed description are to be regarded as illustrative in nature and not restrictive.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings:

FIG. 1 illustrates an example intent-based adaptive power saving flowchart for a multiple technology credential reader.

FIG. 2 illustrates an example intent-based polling method for a multiple technology credential reader.

FIG. 3 illustrates an example traffic-based adaptive power saving flowchart for a multiple technology credential reader.

FIG. 4 illustrates an example device history-based polling method for a multiple technology credential reader.

FIG. 5 illustrates a block diagram schematic of various components of an example reader, such as the multiple technology credential reader discussed herein.

FIG. 6 illustrates a block diagram schematic of various example hardware components of an example machine that can be used as one or more credential-based devices described herein.

### DETAILED DESCRIPTION

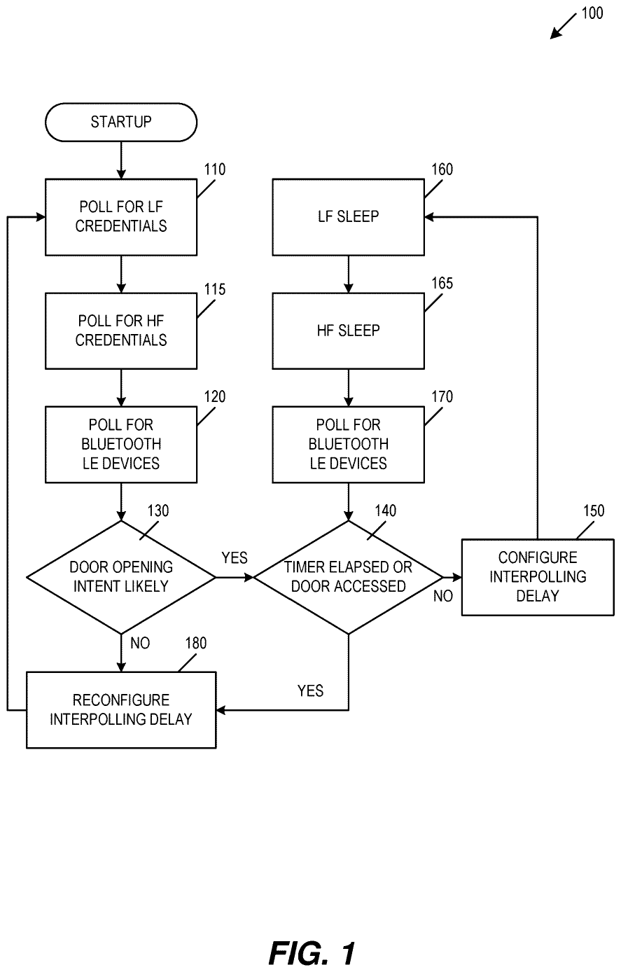

FIG. 1 illustrates an example intent-based adaptive power saving flowchart 100 for a multiple technology credential reader. To provide improved power management, the credential reader may be configured to determine when a user is likely about to access a secure physical or logical asset, such as identifying a user intends to open a secured door (e.g., a door opening intent). In an example, the door opening intent may include identifying when a user approaches a door, such as by identification of a wireless device within a wireless radio range or optical recognition of when a user enters an area around or near the secure physical or logical asset. For example, the credential reader may poll for LF credentials 110, poll for HF credentials 115, and poll for BLE credentials 120. When the credential reader detects one or more credential types, it may identify a door opening intent is likely 130. The door opening intent may be determined using various technologies, such as using a radio to detect a wireless device at a distance from the credential reader. The door opening intent may be based on a measured or determined distance from a credential reader (e.g., distance, proximity), a measured or determined speed of approach determined based on a signal strength indication (e.g., received signal strength indication (RSSI)), or other indication of user device position, proximity, acceleration, or other motion.

Once the credential reader identifies that a door opening intent is likely 130, it may determine 140 whether a door has been accessed within a predetermined door access countdown timer. For example, when using a technology that identifies that a door opening intent is likely 130, the credential reader may begin a ten-second timer. If the credential reader determines that the timer has not yet elapsed, the credential reader may configure the interpolling delay 150 for one or more access credential radios. In an example, configuring the interpolling delay 150 may include causing the LF radio to enter a sleep mode 160, causing the HF radio to enter a sleep mode 165, and causing the BLE radio to poll for BLE devices 170. The sleep mode for the LF or HF radio may include causing the radios to turn off for the duration of the predetermined door access countdown timer or to increase their respective interpolling delay (e.g., increase period between polling events). In an example, the LF and HF radios may typically poll for LF or HF devices at a first interpolling interval (e.g., once every 100 ms, once every 200 ms, or another suitable first polling interval), and the sleep mode may cause the LF and HF radios to reduce their polling cycle to a second interpolling interval that is longer than the first polling interval (e.g., once every 1000 ms, once every 2000 ms, or another suitable second polling interval). Causing the BLE radio to poll for BLE devices 170 may include instructing the BLE radio to poll at its previous interpolling delay, to poll at a reduced interpolling delay (e.g., to reduce power), or to poll at an increased interpolling delay (e.g., to be more responsive to a user requesting access). While the example in flowchart 100 is shown and described with respect to a detected BLE device and HF and LF radios entering sleep mode, a similar process may be used for detection of an HF device (e.g., causing BLE and LF radios to enter sleep mode), for detection of an LF device (e.g., causing BLE and HF radios to enter sleep mode), detection of more than one device, or detection of other access credential technologies (e.g., using facial recognition).

When the credential reader determines 140 that the predetermined door access countdown timer elapsed or that the door has been accessed within the predetermined door access countdown timer, the credential reader may reconfigure the interpolling delay 180. The elapsing of the predetermined door access countdown timer may indicate that a user does not intend to access a protected area, such as when a user is passing by or is loitering near the credential reader. The reconfiguration of the interpolling delay 180 may include returning one or more of the LF radio, the HF radio, or the BLE radio to their respective original interpolling delay. For example, if configuring the interpolling delay 150 included causing the LF and HF radios to reduce their polling cycle to the second interpolling interval, the reconfiguration of the interpolling delay 180 may include returning the LF and HF radios to polling for LF or HF devices based on the first interpolling interval, where the first interpolling interval is shorter than the second polling interval. The reconfiguration of the interpolling delay 180 may be based on one or more previously detected devices. For example, if the credential reader previously identified a door opening intent is likely 130 based on identification of a BLE device, the reconfiguration of the interpolling delay 180 may include causing the BLE radio to reduce a BLE interpolling delay, such as to be more responsive to identifying the same BLE device or similar BLE devices.

The intent-based adaptive power saving flowchart 100 provides various power management improvements. By increasing the interpolling delay on one or more radios, the power consumed by the radio may be proportional to the increase in interpolling delay. For example, modifying an interpolling delay from once every 100 ms to once every 1000 ms may result in an approximately tenfold reduction in power consumption for the affected radios. By turning off one or more radios, the power consumption may be reduced to the power required for one or more remaining radios and powering the credential reader processor. Power management may be further improved by reducing or eliminating power drawn by higher-power radio devices. In the example shown in flowchart 100, if the LF and HF radios draw substantially more power than the BLE radio, then causing the LF radio and HF radio to enter sleep mode may provide a substantial reduction in power consumption. Power management may be further improved by modifying radio interpolling delay based on radio range. In an example, a BLE radio may provide a greater detection distance than LF and HF radios. By increasing the detection range for a lower power BLE radio, more BLE devices may be detected or may be detected more frequently, which may increase the time that the LF radio and HF radios operate in sleep mode.

While flowchart 100 is described with respect to LF, HF, and BLE technologies, the intent-based adaptive power saving shown in flowchart 100 may use various combinations of credential technologies. The selection of devices may be based on considerations similar to those for LF, HF, and BLE technologies, such as detection distance and power consumption. For example, the step of polling for LF credentials 110 in flowchart 100 may more generally represent polling for an access credential technology of relatively higher power or relatively shorter detection distance, such as LF credentials. The step of polling for HF credentials 115 in flowchart 100 may more generally represent polling for an access credential of lower power or longer detection distance than the LF credentials 110, such as polling for near-field communication (NFC) credentials. Similarly, the step of polling for BLE credentials 120 in flowchart 100 may more generally represent polling for an access credential technology of lower power or longer detection distance than either the LF credentials 110 or HF credentials 115, such as BLE, Wi-Fi, or UWB credentials. In an example, a passive credential device (e.g., proximity card) may require more power from the credential reader (e.g., to transfer power an inductive coil within the passive credential device) than an active credential device. In another example, an encrypted credential device may require more power for encryption or decryption of credentials at the credential reader than an unencrypted credential device. While more substantial power savings are expected from causing relatively higher power or shorter range device technologies (e.g., LF, HF) to enter sleep mode, power savings may be realized based on causing lower power or longer range device technologies (e.g., BLE) to enter sleep mode.

While flowchart 100 is described with respect to wireless radio technologies (e.g., LF, HF, BLE), the intent-based adaptive power saving shown in flowchart 100 may use various types of credential technologies. These credential technologies may include short distance credential technologies for which authentication occurs at close proximity to the reader or in physical contact with the reader, such as magnetic strip and fingerprint credentials. Some technologies may use a combination of wireless radios, optical sensors (e.g., motion detector, image capture device), and other sensors to detect a user at various distances. In an example, a facial recognition system may use an image capture device (e.g., video camera) to detect users approaching the credential reader. In another example, the door opening intent may be based on a preliminary doorway, such as a user opening an outer vestibule door or a user opening an elevator door for a credential-based elevator.

The determination of user device position, proximity, acceleration, or other motion may include various thresholds. In an example, a maximum distance of detection of a user device may include detecting a user within 5 m of the credential reader, within 10 m, within 20 m, or within another suitable user detection distance. The detection of a door opening intent may include detection of a wireless device at a distance that is typically closer to the credential reader than the maximum user device detection distance, such as when a credential device (e.g., BLE device) is within 30 cm of the credential reader, within 50 cm, within 1 m, within 10 m, or within another suitable door opening intent distance of the credential reader. The credential reader may be configured to determine whether to allow access to a secure area or asset protected by the credential reader when the credential reader determines that a device is positioned within a close proximity threshold, where the close proximity threshold is typically closer to the credential reader than the detection of a door opening intent. The close proximity threshold may include detecting a device is touching the credential reader, is positioned within 1 cm of the credential reader, within 10 cm, within 15 cm, within 20 cm, or within another close proximity threshold distance of the credential reader. The determination of threshold distances may be based on various considerations, such as technological limits (e.g., maximum radio range in a given environment), power management considerations (e.g., operating a radio at less than full power), or operational considerations. In an example, an operational consideration may include allowing a user to open a secure door without requiring a user to place a BLE device near a reader, and the close proximity threshold may include a range corresponding to a user who is located close enough to open a door.

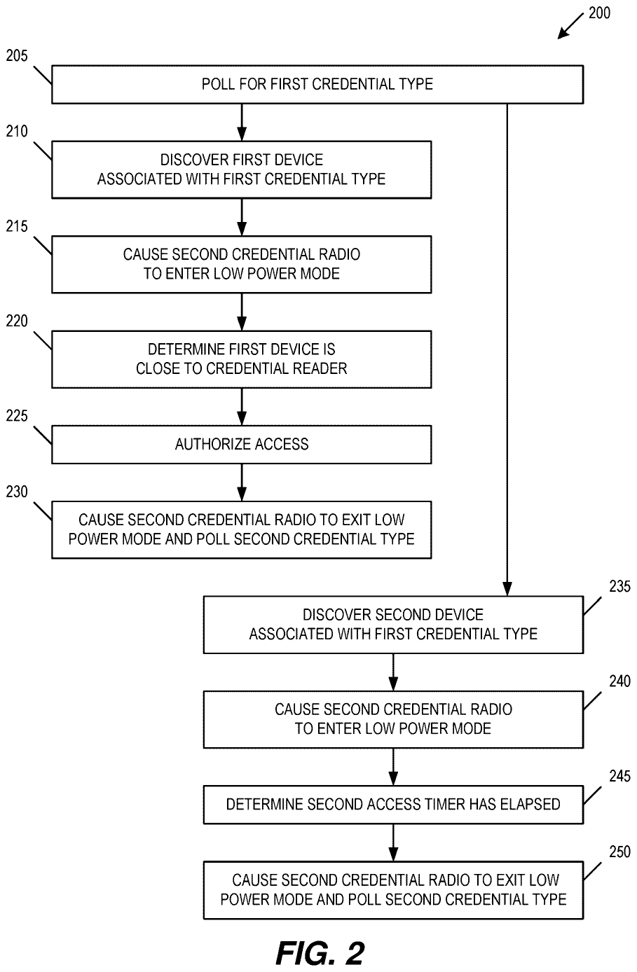

FIG. 2 illustrates an example intent-based polling method 200 for a multiple technology credential reader. Method 200 is shown and described with two main examples, including a credential device being used to gain access to a secure area (e.g., steps 205-230), and including a credential device that is detected but is not used to gain access to a secure area (e.g. steps 205 and 235-245). In the first example, where a credential device is being used to gain access to a secure area, method 200 begins by polling 205 for a first credential type using a first credential radio. The first credential radio may be among a plurality of credential radios included within or coupled to a multiple technology credential reader. Method 200 includes discovering 210 a first device associated with the first credential type using a radio frequency range of the first credential radio, such as identifying a BLE credential device. Method 200 includes causing 215, responsive to discovering the first device, at least a second credential radio associated with a second credential type to enter a low power mode. This may include causing LF and HF radios to enter a sleep mode. In an example, a first interpolling delay may be reduced for the first credential radio, such as to poll more frequently for the BLE credential device. The reduction in the first interpolling delay may occur before, during, or substantially simultaneously with causing 215 at least a second credential radio to enter a low power mode.

Method 200 includes determining 220 the first device is positioned within a close proximity threshold range of the multiple technology credential reader. In response to determining the first device is positioned within the close proximity threshold range, method 200 includes authorizing 225 access for the first device. The close proximity threshold range may be based on the first device being positioned adjacent to or within a predetermined range of the multiple technology credential reader, such as within 1 m, within 10 cm, within 1 cm, in physical contact with the reader, or another suitable distance. Authorizing the physical access for the first device may be further responsive to determining a first access timer has not elapsed, such as to indicate the BLE credential device is requesting access within a predetermined time window.

Causing 215 the second credential radio to enter the low power mode may include causing the second credential radio to refrain from polling for the second credential type. Causing 215 the second credential radio to enter the low power mode may include increasing an interpolling delay of the second credential radio or turning off the second credential radio. Causing 215 the second credential radio to enter a low power mode can substantially reduce a device power consumption of the multiple technology credential reader. Method 200 may further include causing 230, subsequent to authorizing the physical access for the first device, the second credential radio to exit the low power mode and poll for the second credential type. In an example, if the first interpolling delay was reduced for the first credential radio, the first interpolling delay may be returned to a default value or to its previous delay value. This modification of the first interpolling delay may occur before, during, or substantially simultaneously with causing 230 the second credential radio to exit the low power mode.

In the second example, where a credential device is detected but not used to gain access to a secure area, method 200 begins by polling 205 for the first credential type using the first credential radio. Method 200 further includes discovering 235 a second device associated with the first credential type within the radio frequency range of the first credential radio, such as identifying another BLE credential device. Method 200 includes causing 240, responsive to discovering the second device, at least a second credential radio associated with a second credential type to enter a low power mode. In an example, a first interpolling delay may be reduced for the first credential radio, which may occur before, during, or substantially simultaneously with causing 240 at least a second credential radio to enter a low power mode.

Method 200 further includes determining 245 a second access timer has elapsed. The second access timer may be used to determine whether the BLE credential device has been positioned within the close proximity threshold range of the multiple technology credential reader within a predetermined time window. Inn example, the elapsing of the second access timer may occur when a user is passing by or is loitering near the credential reader. In response to determining 245 a second access timer has elapsed, method 200 includes causing 250 the second credential radio to exit the low power mode and poll for the second credential type. In an example, if the first interpolling delay was reduced for the first credential radio, the first interpolling delay may be returned to a default value or to its previous delay value, which may occur before, during, or substantially simultaneously with causing 240 at least a second credential radio to enter a low power mode.

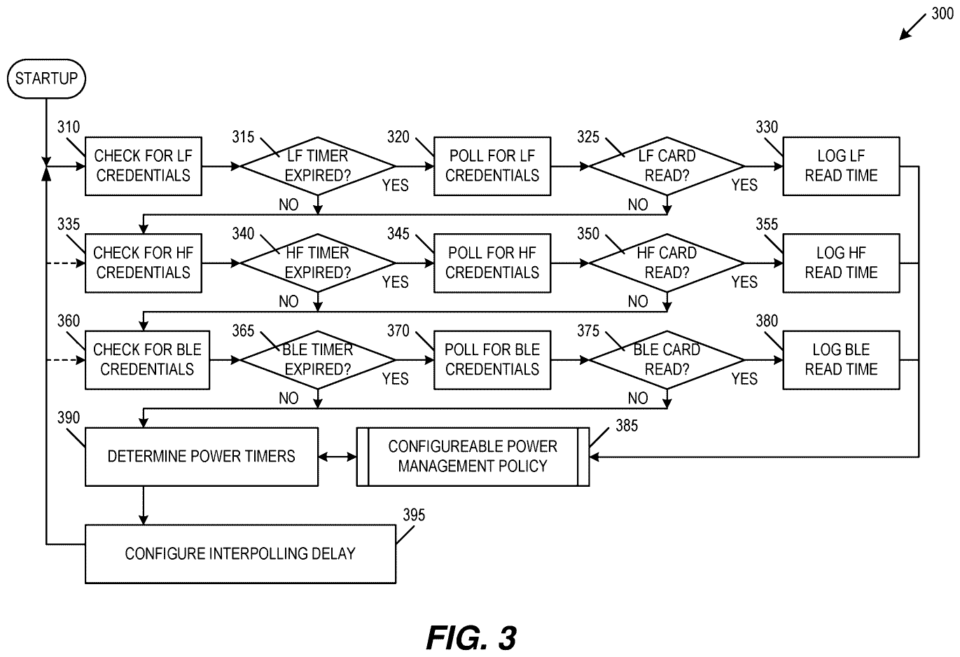

FIG. 3 illustrates an example traffic-based adaptive power saving flowchart 300 for a multiple technology credential reader. To provide improved power management, the credential reader may be configured to monitor credential usage and categorize based on credential traffic type, and may reconfigure one or more interpolling delays for credential traffic types based on recent credential traffic. While the example shown in flowchart 300 is shown and described as having a sequential flow through LF credentials (e.g., starting at 310), then HF credentials (e.g., starting at 335), and finally BLE credentials (e.g., starting at 360), other credential orders may be possible. For example, the flowchart 300 may instead begin with HF credentials, may begin with BLE credentials, or may process two or more credential types substantially simultaneously.

A first example path through flowchart 300 may include identifying only BLE credentials. In this first example, a credential reader may start with a check for LF credentials 310, and may determine whether an LF interpolling timer has expired 315. In an example, the LF interpolling timer may indicate an additional 500 ms need to elapse before polling for LF credentials. If it is determined that the LF interpolling timer has not expired (e.g., the LF radio is not active), the credential reader may check for HF credentials 335, and may determine whether an HF interpolling timer has expired 340. In an example, the HF interpolling timer may indicate an additional 100 ms need to elapse before polling for HF credentials. If it is determined that the HF interpolling timer has not expired 340, the credential reader may check for BLE credentials 360, and may determine whether a BLE interpolling timer has not expired 365. In response to determining that the BLE interpolling timer has expired, the credential reader may poll for BLE credentials 370, read a BLE card 375, and log a BLE read time 380.

After logging the BLE read time 380, the credential reader may retrieve a configurable power management policy 385, determine one or more credential interpolling timers 390, and configure the interpolling delay 395. Configuring the interpolling delay 395 may include modifying one or more of the LF interpolling timer used in 315, the HF interpolling timer used in 340, and the BLE interpolling timer used in 365. The determination of credential interpolling timers 390 and configuration of the interpolling delay 395 may be based on a combination of the retrieved configurable power management policy 385 and the logging of the BLE read time 380. In this first example where only a BLE card is read 375, the BLE interpolling timer may be configured to reduce an interpolling delay for BLE devices and increase an interpolling delay for LF and HF devices. In another example, if logged read times indicate an increase in the use of BLE devices relative to LF and HF devices, the BLE interpolling timer may be configured to reduce an interpolling delay for BLE devices and increase an interpolling delay for LF and HF devices. The increase in interpolling delay for LF and HF devices may provide reduced power consumption by reducing the power required for polling for LF and HF devices.

A second example path through flowchart may include identifying only an LF device. In the second example, the credential reader may start with a check for LF credentials 310, determine whether the LF interpolling timer has expired 315, poll for an LF card 320, read an LF card 325, and log an LF read time 330. After logging the LF read time 380, the credential reader may retrieve the configurable power management policy 385, determine one or more credential interpolling timers 390, and configure the interpolling delay 395. The determination of credential interpolling timers 390 and configuration of the interpolling delay 395 may be based on a combination of the retrieved configurable power management policy 385 and the logging of the LF read time 330. In this second example where only an LF card is read 375, the LF interpolling timer may be configured to reduce an interpolling delay for LF devices, and may increase an interpolling delay for HF and BLE devices. In another example, if logged read times indicate an increase in the use of LF devices relative to HF and BLE devices, the LF interpolling timer may be configured to reduce an interpolling delay for LF devices and increase an interpolling delay for HF and BLE devices. The increase in interpolling delay for HF and BLE devices may provide reduced power consumption by reducing the power required for polling for HF and BLE devices.

A third example path through flowchart may include identifying only an HF device. In the third example, the credential reader may start with a check for LF credentials 310, determine whether an LF interpolling timer has not expired 315, check for HF credentials 335, determine whether an HF interpolling timer has expired 340, poll for HF credentials 345, read an HF card 350, and log an HF read time 355. After logging the HF read time 355, the credential reader may retrieve the configurable power management policy 385, determine one or more credential interpolling timers 390, and configure the interpolling delay 395. The determination of credential interpolling timers 390 and configuration of the interpolling delay 395 may be based on a combination of the retrieved configurable power management policy 385 and the logging of the HF read time 355. In this third example where only an HF card is read 350, the HF interpolling timer may be configured to reduce an interpolling delay for HF devices, and may increase an interpolling delay for LF and BLE devices. In another example, if logged read times indicate an increase in the use of HF devices relative to LF and BLE devices, the HF interpolling timer may be configured to reduce an interpolling delay for HF devices and increase an interpolling delay for LF and BLE devices. The increase in interpolling delay for LF and BLE devices may provide reduced power consumption by reducing the power required for polling for LF and BLE devices.

The configurable power management policy 385 may be based on various power management considerations. The power management policy 385 may be based on access credential deployment, such as reducing interpolling delay for commonly deployed devices (e.g., BLE devices) and increasing interpolling delay for relatively infrequently deployed devices (e.g., LF and HF devices). The power management policy 385 may be based on timing, such as increasing an interpolling delay for one or more devices based on time of day, day of week, a holiday schedule, or other timing consideration. The power management policy 385 may be configured by an organization based on one or more personnel policies, such as to encourage or discourage the usage of one or more credential types. For example, an organization may discourage use of LF or HF devices and may encourage use of BLE devices for all times, or may require personnel to use BLE devices during certain time periods (e.g., weekends).

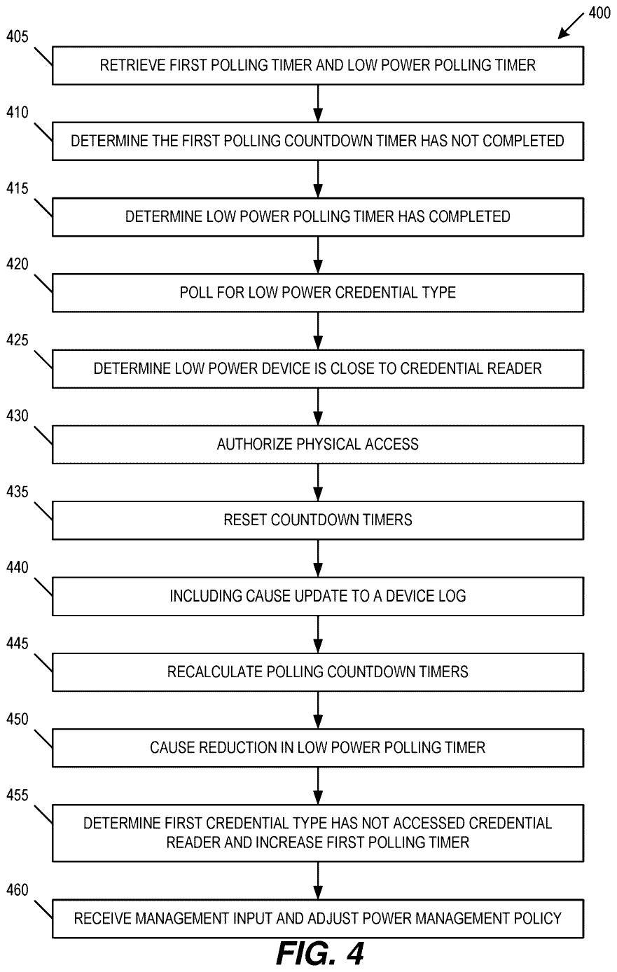

FIG. 4 illustrates an example device history-based polling method 400 for a multiple technology credential reader. Method 400 includes retrieving 405, at a multiple technology credential reader, a first polling countdown timer and a low power polling countdown timer. The first polling countdown timer and low power polling countdown timer may be among a plurality of countdown timers stored in a memory of the multiple technology credential reader. Method 400 includes determining 410 the first polling countdown timer has not completed. The first polling countdown timer may be associated with a first credential type and a first credential radio coupled to the multiple technology credential reader. Method 400 includes determining 415 the low power polling countdown timer has completed. The low power polling countdown timer may be associated with a low power credential type and a low power credential radio. Method 400 includes polling 420 for the low power credential type using the low power credential radio. Method 400 includes determining 425 a low power device associated with the low power credential type is positioned within a close proximity threshold range of the multiple technology credential reader. Method 400 includes authorizing 430 a physical access for the low power device responsive to determining the low power device is positioned within the close proximity threshold range. The first credential radio may be associated with a higher power consumption than the low power credential radio. The first polling countdown timer may be greater than the low power polling countdown timer such that the first credential radio may be polled less frequently than the low power credential radio to reduce an overall power consumption. Method 400 may further include resetting 435 each of the plurality of countdown timers responsive to authorizing the physical access for the low power device, such as returning the first countdown timers to a default value or to their respective previous values. Method 400 may further include including causing 440 an update to a device log based on the physical access for the low power device. The device log may include a record of a plurality of historical physical access authorizations.

Method 400 may further include recalculating 445 all polling countdown timers based on the update to the device log. The device log may include a rolling window average associated with each credential type. The rolling window average may include a number of physical accesses within a predetermined rolling window duration. Method 400 may further include causing 450 a reduction in the low power polling countdown timer responsive to the physical access for the low power device, the reduction in the low power polling countdown timer indicating an increased usage of devices associated with low power credential radio.

Method 400 may further include determining 455, based on the device log, that the first credential type has not accessed the multiple technology credential reader within a predetermined access window, and increasing the first polling countdown timer to reduce a first power consumption by the first credential radio. Responsive to authorizing the physical access for the low power device, each of the plurality of countdown timers may be set based on the device log and based on a power management policy. The power management policy may include setting the plurality of countdown timers based on at least one of a time of day, a day of a week, and a holiday schedule. Method 400 may further include receiving 460 a power management input and adjusting the power management policy based on the power management input.

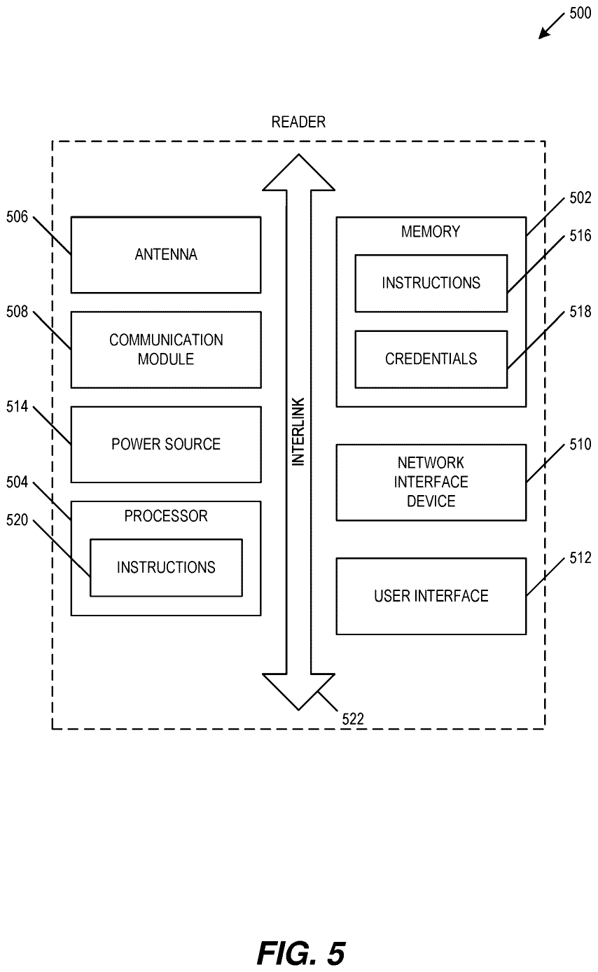

FIG. 5 illustrates a block diagram schematic of various components of an example reader 500, such as the multiple technology credential reader discussed herein. In general, reader 500 can include one or more of a memory 502, a processor 504, one or more antennas 506, a communication module 508, a network interface device 510, a user interface 512, and a power source or supply 514. Reader 500 may include a device affixed to a surface (e.g. wall, door), though reader 500 may also be a free-standing device or a portable device (e.g., mobile electronic device).

Memory 502 can be used in connection with the execution of application programming or instructions by processor 504, and for the temporary or long-term storage of program instructions or instruction sets 516 or credential or authorization data 518, such as credential data, credential authorization data, or access control data or instructions. For example, memory 502 can contain executable instructions 516 that are used by the processor 504 to run other components of reader 500 and make access determinations based on credential or authorization data 518. Memory 502 can comprise a computer readable medium that can be any medium that can contain, store, communicate, or transport data, program code, or instructions for use by or in connection with reader 500. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), any solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Processor 504 can correspond to one or more computer processing devices or resources. For instance, processor 504 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 504 can be provided as a microprocessor, Central Processing Unit (CPU), or plurality of microprocessors or CPUs that are configured to execute instructions sets stored in an internal memory 520 or memory 502.

Antenna 506 can correspond to one or multiple antennas and can be configured to provide for wireless communications between, for example, reader 500 and a credential or key device. Antenna(s) 506 can be arranged to operate using one or more wireless communication protocols and operating frequencies such as the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 506 can be RF antenna(s), and as such, may transmit/receive RF signals through free-space to be received/transferred by a credential or key device having an RF transceiver.

Communication module 508 can be configured to communicate according to any suitable communications protocol with one or more different systems or devices either remote or local to reader 500, such as one or more control mechanisms 306 or control panel 308.

Network interface device 510 includes hardware to facilitate communications with other devices, such as a control panel or host server over a communication network, using any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi or IEEE 802.16 family of standards known as WiMax), networks based on the IEEE 802.15.4 family of standards, and peer-to-peer (P2P) networks, among others. In some examples, network interface device 510 can include an Ethernet port or other physical jack, a Wi-Fi card, a Network Interface Card (NIC), a cellular interface (e.g., antenna, filters, and associated circuitry), or the like. In some examples, network interface device 510 can include one or more antennas to wirelessly communicate using, for example, at least one of single-input multiple-output (SIMO), multiple-input multiple-output (MIMO), or multiple-input single-output (MISO) techniques.

User interface 512 can include one or more input devices or display devices. Examples of suitable user input devices that can be included in user interface 512 include, without limitation, one or more buttons, a keyboard, a mouse, a touch-sensitive surface, a stylus, a camera, a microphone, a PIN pad, touch screen, fingerprint reader, magnetic stripe reader, chip reader, etc. Examples of suitable user output devices that can be included in user interface 512 include, without limitation, one or more LEDs, an LCD panel, a display screen, a touchscreen, one or more lights, a speaker, etc. It should be appreciated that user interface 512 can also include a combined user input and user output device, such as a touch-sensitive display or the like.

Power source 514 can be any suitable internal power source, such as a battery, capacitive power source or similar type of charge-storage device, etc., or can include one or more power conversion circuits suitable to convert external power into suitable power (e.g., conversion of externally supplied AC power into DC power) for components of the reader 500. Power source 514 can also include some implementation of surge protection circuitry to protect the components of reader 500 from power surges.

Reader 500 can also include one or more busses or interlinks 522 operable to transmit communications between the various hardware components of the reader. A system bus or interlink 522 can be any of several types of commercially available bus structures or bus architectures. A computing device or credential reader manager may reconfigure the reader 500 by connecting a device to the reader 500 via bus or interlink 522, such as by changing device parameters (e.g., configurable interpolling delays), by overwriting a device management policy, by updating software, by reflashing firmware, or other reconfigurations.

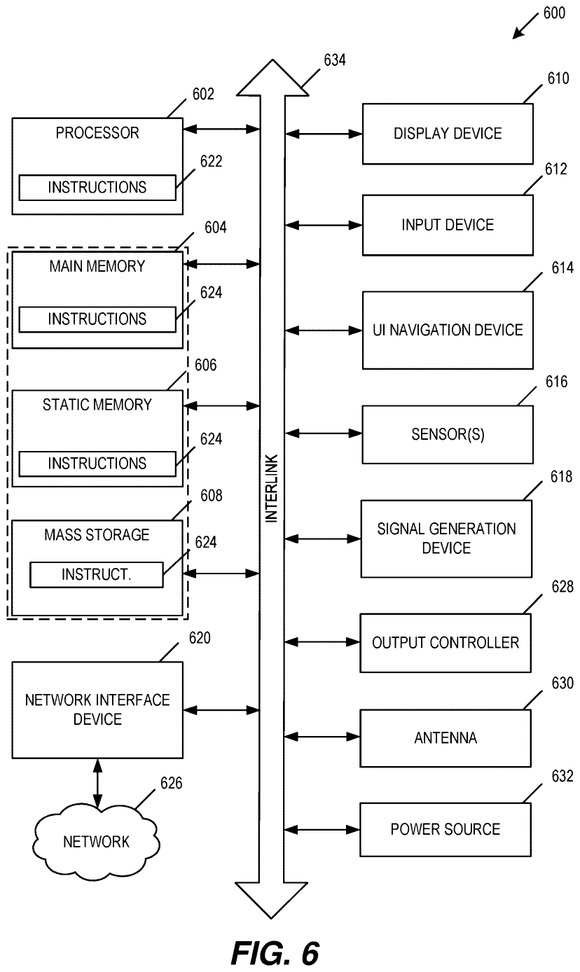

FIG. 6 illustrates a block diagram schematic of various example hardware components of an example machine 600 that can be used as, for example, one or more credential-based devices described herein. These credential-based devices may include one or more of a credential reader (e.g., reader 500), a credential reader manager device that is connected to a credential reader (e.g., to reflash the credential reader), a computing device (e.g., a computer allowing a user to enter input to update a power management policy), or a credential device (e.g., BLE device). These devices may include one or more of the example components illustrated in FIG. 6, which may depend on the form factor of the device. Examples, as described herein, can generally include, or can operate by, logic or a number of components, modules, or mechanisms in machine 600. Modules may be hardware, software, or firmware communicatively coupled to one or more processors in order to carry out the operations described herein. Generally, circuitry (e.g., processing circuitry) of example machine 600 may include a collection of circuits implemented in tangible entities of the machine 600 that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional or more specific examples of components with respect to machine 600 follow.

In some embodiments, machine 600 can operate as a standalone device or can be connected (e.g., networked) to other machines. In a networked deployment, machine 600 can operate in the capacity of a server machine, a client machine, or both in server-client network environments. In some examples, machine 600 can act as a peer machine in a peer-to-peer (P2P) (or other distributed) network environment. Machine 600 can be or include a PC, a tablet PC, a set-top box (STB), a PDA, a mobile telephone, a web appliance, a network router, switch or bridge, an RFID smartcard or other proximity-based card, access control card, electronic key, key fob, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Machine (e.g., computer system) 600 can include a hardware processor 602 (e.g., a central processing unit (CPU), a graphics processing unit (GPU), a hardware processor core, or any combination thereof) and a main memory 604, a static memory (e.g., memory or storage for firmware, microcode, a basic-input-output (BIOS), unified extensible firmware interface (UEFI), etc.) 606, or mass storage 608 (e.g., hard drives, tape drives, flash storage, or other block devices) some or all of which can communicate with each other via an interlink (e.g., bus) 634. Machine 600 can further include a display device 610, an input device 612, or a user interface (UI) navigation device 614. Examples of suitable display devices include, without limitation, one or more LEDs, a LCD panel, a display screen, a touchscreen, one or more lights, etc. Example input devices and UI navigation devices include, without limitation, one or more buttons, a keyboard, a touch-sensitive surface, a stylus, a camera, a microphone, etc. In some examples, one or more of the display device 610, input device 612, or UI navigation device 614 can be a combined unit, such as a touch screen display. Machine 600 can additionally include a signal generation device 618 (e.g., a speaker), a network interface device 620, one or more antennas 630, a power source 632, and one or more sensors 616, such as a global positioning system (GPS) sensor, compass, accelerometer, or other sensor. Machine 600 can include an output controller 628, such as a serial (e.g., universal serial bus (USB)), parallel, or other wired or wireless (e.g., infrared (IR), NFC, etc.) connection to communicate with or control one or more peripheral devices (e.g., a printer, card reader, etc.).

Processor 602 can correspond to one or more computer processing devices or resources. For instance, processor 602 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 602 can be provided as a microprocessor, Central Processing Unit (CPU), or plurality of microprocessors or CPUs that are configured to execute instructions sets stored in an internal memory 622 or memory 604, 606, 608.

Any of memory 604, 606, and 608 can be used in connection with the execution of application programming or instructions by processor 602 for performing any of the functionality or methods described herein, and for the temporary or long-term storage of program instructions or instruction sets 624 or other data for performing any of the functionality or methods described herein, such as for in-field encoding of access credentials as described herein. Any of memory 604, 606, 608 can comprise a computer readable medium that can be any medium that can contain, store, communicate, or transport data, program code, or instructions 624 for use by or in connection with machine 600. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. As noted above, computer readable media includes, but is not to be confused with, computer readable storage medium, which is intended to cover all physical, non-transitory, or similar embodiments of computer readable media.

Network interface device 620 includes hardware to facilitate communications with other devices over a communication network, using any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi or IEEE 802.16 family of standards known as WiMax), networks based on the IEEE 802.15.4 family of standards, and peer-to-peer (P2P) networks, among others. In some examples, network interface device 620 can include an Ethernet port or other physical jack, a Wi-Fi card, a Network Interface Card (NIC), a cellular interface (e.g., antenna, filters, and associated circuitry), or the like. In some examples, network interface device 620 can include one or more antennas to wirelessly communicate using, for example, at least one of single-input multiple-output (SIMO), multiple-input multiple-output (MIMO), or multiple-input single-output (MISO) techniques.

Antenna 630 can correspond to one or multiple antennas and can be configured to provide for wireless communications between machine 600 and another device. Antenna(s) 630 can be arranged to operate using one or more wireless communication protocols and operating frequencies including the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 630 can be RF antenna(s), and as such, may transmit/receive RF signals through free-space to be received/transferred by another device having an RF transceiver.

Power source 632 can be any suitable internal power source, such as a battery, capacitive power source or similar type of charge-storage device, etc., or can include one or more power conversion circuits suitable to convert external power into suitable power (e.g., conversion of externally-supplied AC power into DC power) for components of the machine 600. Power source 632 can also include some implementation of surge protection circuitry to protect the components of machine 600 from power surges. As indicated above, machine 600 can include one or more interlinks or buses 634 operable to transmit communications between the various hardware components of the machine. A system bus 634 can be any of several types of commercially available bus structures or bus architectures.

With reference back to FIGS. 1-5, a user may approach a credential reader 500, and a credential device may communicate the user's credential or credential data to the credential reader 500, for example, via a suitable RFID or PAN technology. In some examples, a user credential device may include be a portable device having memory, storing one or more user credentials or credential data, and a reader interface (i.e., an antenna and Integrated Circuit (IC) chip), which permits the credential to exchange data with a reader device, such as credential reader 500, via a credential interface of the reader device, such as antenna 506. More generally, and as indicated above, the credential device may include some, any, or all of the various components described above with respect to the block diagram schematic of FIG. 6. In some example embodiments, reader 500 and credential device may be the same device, wherein, for example, the user may be attempting to access a logical asset via the user's own mobile device. If credential reader 500 or other device determines that the user's credential or credential data provided by credential device is valid or authorized, credential reader 500 may operate a control mechanism to allow access to a secure physical asset by the user having the credential device.

### Additional Examples

Example 1 is a system for adaptive power saving for a multiple technology credential reader, the system comprising: a multiple technology credential reader including a plurality of credential radios, processing circuitry, and a memory that includes instructions, the instructions, when executed by the processing circuitry, cause the multiple technology credential reader to: poll for a first credential type using a first credential radio within the plurality of credential radios; discover a first device associated with the first credential type within a radio frequency range of the first credential radio; cause, responsive to discovering the first device, a second credential radio associated with a second credential type to enter a low power mode; determine the first device is positioned within a close proximity threshold range of the multiple technology credential reader; and authorize a credential access for the first device responsive to determining the first device is positioned within the close proximity threshold range.

In Example 2, the subject matter of Example 1 includes further subject matter where authorizing the credential access for the first device is further responsive to determining a first access timer has not elapsed.

In Example 3, the subject matter of Examples 1-2 includes further subject matter where the low power mode includes causing the second credential radio to refrain from polling for the second credential type.

In Example 4, the subject matter of Examples 1-3 includes further subject matter where the low power mode includes turning off all of the plurality of credential radios except for the first credential radio.

In Example 5, the subject matter of Examples 1-4 includes further subject matter where: the second credential radio draws more power during polling than the first credential radio; and causing the second credential radio to enter a low power mode substantially reduces a device power consumption of the multiple technology credential reader.

In Example 6, the subject matter of Examples 1-5 includes further subject matter where subsequent to authorizing the credential access for the first device, the instructions further cause the second credential radio to exit the low power mode and poll for the second credential type.

In Example 7, the subject matter of Examples 1-6 includes instructions further causing the multiple technology credential reader to: discover a second device associated with the first credential type within the radio frequency range of the first credential radio; determine a second access timer has elapsed, the second access timer elapsing indicating the second device has not been positioned within the close proximity threshold range of the multiple technology credential reader; and cause the second credential radio to exit the low power mode and poll for the second credential type.

In Example 8, the subject matter of Examples 1-7 includes instructions further causing, responsive to discovering the first device, the first credential radio to reduce an access polling time interval associated with authorizing the credential access.

In Example 9, the subject matter of Examples 1-8 includes further subject matter where the close proximity threshold range is based on the first device being positioned adjacent to the multiple technology credential reader.

In Example 10, the subject matter of Examples 1-9 includes instructions further causing the multiple technology credential reader to reduce a polling time interval associated with the plurality of credential radios based on at least one of a time of day, a day of a week, and a holiday schedule.

In Example 11, the subject matter of Examples 1-10 includes further subject matter where: the first credential type includes a Bluetooth low energy device; and the second credential type includes a passive radio frequency access device.

In Example 12, the subject matter of Example 11 includes further subject matter where: the plurality of credential radios further includes a third credential type; and the third credential type includes an active radio frequency access device.

In Example 13, the subject matter of Example 12 includes further subject matter where: the passive radio frequency access device includes a low frequency access device; and the active radio frequency access device includes a high frequency access device.

In Example 14, the subject matter of Examples 1-13 includes further subject matter where the credential access includes at least one of a physical access and a logical access.

Example 15 is a method for adaptive power saving for a multiple technology credential reader, the method comprising: polling for a first credential type using a first credential radio, the first credential radio among a plurality of credential radios coupled to a multiple technology credential reader; discovering a first device associated with the first credential type within a radio frequency range of the first credential radio; causing, responsive to discovering the first device, a second credential radio associated with a second credential type to enter a low power mode; determining the first device is positioned within a close proximity threshold range of the multiple technology credential reader; and authorizing a credential access for the first device responsive to determining the first device is positioned within the close proximity threshold range.

In Example 16, the subject matter of Example 15 includes further subject matter where authorizing the credential access for the first device is further responsive to determining a first access timer has not elapsed.

In Example 17, the subject matter of Examples 15-16 includes further subject matter where the low power mode includes causing the second credential radio to refrain from polling for the second credential type.

In Example 18, the subject matter of Examples 15-17 includes further subject matter where the low power mode includes turning off all of the plurality of credential radios except for the first credential radio.

In Example 19, the subject matter of Examples 15-18 includes further subject matter where: the second credential radio draws more power during polling than the first credential radio; and causing the second credential radio to enter a low power mode substantially reduces a device power consumption of the multiple technology credential reader.

In Example 20, the subject matter of Examples 15-19 includes causing, subsequent to authorizing the credential access for the first device, the second credential radio to exit the low power mode and poll for the second credential type.

In Example 21, the subject matter of Examples 15-20 includes discovering a second device associated with the first credential type within the radio frequency range of the first credential radio; determining a second access timer has elapsed, the second access timer elapsing indicating the second device has not been positioned within the close proximity threshold range of the multiple technology credential reader, and causing the second credential radio to exit the low power mode and poll for the second credential type.

In Example 22, the subject matter of Examples 15-21 includes responsive to discovering the first device, reducing an access polling time interval associated with authorizing the credential access.

In Example 23, the subject matter of Examples 15-22 includes further subject matter where the close proximity threshold range is based on the first device being positioned adjacent to the multiple technology credential reader.

In Example 24, the subject matter of Examples 15-23 includes reducing a polling time interval associated with the plurality of credential radios based on at least one of a time of day, a day of a week, and a holiday schedule.

In Example 25, the subject matter of Examples 15-24 includes further subject matter where: the first credential type includes a Bluetooth low energy device; and the second credential type includes a passive radio frequency access device.

In Example 26, the subject matter of Example 25 includes further subject matter where: the plurality of credential radios further includes a third credential type; and the third credential type includes an active radio frequency access device.

In Example 27, the subject matter of Example 26 includes further subject matter where: the passive radio frequency access device includes a low frequency access device; and the active radio frequency access device includes a high frequency access device.

In Example 28, the subject matter of Examples 15-27 includes further subject matter where the credential access includes at least one of a physical access and a logical access.

Example 29 is a system for adaptive power saving for a multiple technology credential reader, the system comprising: a multiple technology credential reader including a plurality of credential radios, processing circuitry, and a memory that includes instructions, the instructions, when executed by the processing circuitry, cause the multiple technology credential reader to: retrieve a first polling countdown timer and a low power polling countdown timer from among a plurality of countdown timers stored in the memory; determine the first polling countdown timer has not completed, the first polling countdown timer associated with a first credential type and a first credential radio; determine the low power polling countdown timer has completed, the low power polling countdown timer associated with a low power credential type and a low power credential radio; poll for the low power credential type using the low power credential radio; determine a low power device associated with the low power credential type is positioned within a close proximity threshold range of the multiple technology credential reader; and authorize a credential access for the low power device responsive to determining the low power device is positioned within the close proximity threshold range.

In Example 30, the subject matter of Example 29 includes further subject matter where: the first credential radio is associated with a higher power consumption than the low power credential radio; and the first polling countdown timer is greater than the low power polling countdown timer such that the first credential radio is polled less frequently than the low power credential radio to reduce an overall power consumption.

In Example 31, the subject matter of Examples 29-30 includes instructions further causing the multiple technology credential reader to reset each of the plurality of countdown timers responsive to authorizing the credential access for the low power device.

In Example 32, the subject matter of Examples 29-31 includes instructions further cause the multiple technology credential reader to cause an update to a device log based on the credential access for the low power device, the device log including a record of a plurality of historical credential access authorizations.

In Example 33, the subject matter of Example 32 includes instructions further cause the multiple technology credential reader to recalculate all polling countdown timers based on the update to the device log.

In Example 34, the subject matter of Examples 32-33 includes further subject matter where the device log includes a rolling window average associated with each credential type.

In Example 35, the subject matter of Example 34 includes further subject matter where the rolling window average includes a number of credential accesses within a predetermined rolling window duration.

In Example 36, the subject matter of Examples 32-35 includes instructions further cause the multiple technology credential reader to cause a reduction in the low power polling countdown timer responsive to the credential access for the low power device, the reduction in the low power polling countdown timer indicating an increased usage of devices associated with low power credential radio.

In Example 37, the subject matter of Examples 32-36 includes instructions further cause the multiple technology credential reader to: determine, based on the device log, that the first credential type has not accessed the multiple technology credential reader within a predetermined access window; and increase the first polling countdown timer to reduce a first power consumption by the first credential radio.

In Example 38, the subject matter of Examples 32-37 includes further subject matter where responsive to authorizing the credential access for the low power device, the instructions further causing the multiple technology credential reader to set each of the plurality of countdown timers based on the device log and based on a power management policy.

In Example 39, the subject matter of Example 38 includes further subject matter where power management policy includes setting the plurality of countdown timers based on at least one of a time of day, a day of a week, and a holiday schedule.

In Example 40, the subject matter of Examples 38-39 includes instructions further cause the multiple technology credential reader to: receive a power management input; and adjust the power management policy based on the power management input.

In Example 41, the subject matter of Examples 29-40 includes further subject matter where after determining the first polling countdown timer has not completed and before determining the low power polling countdown timer has completed, the instructions further cause the multiple technology credential reader to determine a second polling countdown timer has not completed, the second polling countdown timer associated with a second credential type and a second credential radio.

In Example 42, the subject matter of Examples 29-41 includes further subject matter where the credential access includes at least one of a physical access and a logical access.

Example 43 is a method for adaptive power saving for a multiple technology credential reader, the method comprising: retrieving, at a multiple technology credential reader, a first polling countdown timer and a low power polling countdown timer from among a plurality of countdown timers stored in a memory of the multiple technology credential reader; determining the first polling countdown timer has not completed, the first polling countdown timer associated with a first credential type and a first credential radio coupled to the multiple technology credential reader; determining the low power polling countdown timer has completed, the low power polling countdown timer associated with a low power credential type and a low power credential radio; polling for the low power credential type using the low power credential radio; determining a low power device associated with the low power credential type is positioned within a close proximity threshold range of the multiple technology credential reader; and authorizing a credential access for the low power device responsive to determining the low power device is positioned within the close proximity threshold range.

In Example 44, the subject matter of Example 43 includes further subject matter where: the first credential radio is associated with a higher power consumption than the low power credential radio; and the first polling countdown timer is greater than the low power polling countdown timer such that the first credential radio is polled less frequently than the low power credential radio to reduce an overall power consumption.

In Example 45, the subject matter of Examples 43-44 includes resetting each of the plurality of countdown timers responsive to authorizing the credential access for the low power device.

In Example 46, the subject matter of Examples 43-45 includes causing an update to a device log based on the credential access for the low power device, the device log including a record of a plurality of historical credential access authorizations.

In Example 47, the subject matter of Example 46 includes recalculating all polling countdown timers based on the update to the device log.

In Example 48, the subject matter of Examples 46-47 includes further subject matter where the device log includes a rolling window average associated with each credential type.

In Example 49, the subject matter of Example 48 includes further subject matter where the rolling window average includes a number of credential accesses within a predetermined rolling window duration.

In Example 50, the subject matter of Examples 46-49 includes causing a reduction in the low power polling countdown timer responsive to the credential access for the low power device, the reduction in the low power polling countdown timer indicating an increased usage of devices associated with low power credential radio.

In Example 51, the subject matter of Examples 46-50 includes determining, based on the device log, that the first credential type has not accessed the multiple technology credential reader within a predetermined access window; and increasing the first polling countdown timer to reduce a first power consumption by the first credential radio.

In Example 52, the subject matter of Examples 46-51 includes further subject matter where, responsive to authorizing the credential access for the low power device, further including setting each of the plurality of countdown timers based on the device log and based on a power management policy.

In Example 53, the subject matter of Example 52 includes further subject matter where power management policy includes setting the plurality of countdown timers based on at least one of a time of day, a day of a week, and a holiday schedule.

In Example 54, the subject matter of Examples 52-53 includes receiving a power management input; and adjusting the power management policy based on the power management input.

In Example 55, the subject matter of Examples 43-54 includes determining, after determining the first polling countdown timer has not completed and before determining the low power polling countdown timer has completed, a second polling countdown timer has not completed, the second polling countdown timer associated with a second credential type and a second credential radio.

In Example 56, the subject matter of Examples 43-55 includes further subject matter where the credential access includes at least one of a physical access and a logical access.

Example 57 is at least one machine-readable medium including instructions that, when executed by processing circuitry, cause the processing circuitry to perform operations to implement of any of Examples 1-56.

Example 58 is an apparatus comprising means to implement of any of Examples 1-56.

Example 59 is a system to implement of any of Examples 1-56.

Example 60 is a method to implement of any of Examples 1-56.

### Additional Notes

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As will be appreciated by one of skill in the art, the various embodiments of the present disclosure may be embodied as a method (including, for example, a computer-implemented process, a business process, or any other process), apparatus (including, for example, a system, machine, device, computer program product, or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. As indicated above, the computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical, magnetic, or solid state storage device. As noted above, computer-readable media includes, but is not to be confused with, computer-readable storage medium, which is intended to cover all physical, non-transitory, or similar embodiments of computer-readable media.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A system for adaptive power saving for a multiple technology credential reader, the system comprising:
a multiple technology credential reader including a plurality of credential radios, processing circuitry, and a memory that includes instructions, the instructions, when executed by the processing circuitry, cause the multiple technology credential reader to:
poll for a first credential type using a first credential radio within the plurality of credential radios;
discover a first device associated with the first credential type within a radio frequency range of the first credential radio;
cause, responsive to discovering the first device, a second credential radio associated with a second credential type to enter a low power mode;
determine the first device is positioned within a close proximity threshold range of the multiple technology credential reader; and
authorize a credential access for the first device responsive to determining the first device is positioned within the close proximity threshold range.

2. (canceled)

3. The system of claim 1, wherein the low power mode includes causing the second credential radio to refrain from polling for the second credential type.

4. (canceled)

5. The system of claim 1, wherein:
the second credential radio draws more power during polling than the first credential radio; and
causing the second credential radio to enter a low power mode substantially reduces a device power consumption of the multiple technology credential reader.

6. The system of claim 1, wherein subsequent to authorizing the credential access for the first device, the instructions further cause the second credential radio to exit the low power mode and poll for the second credential type.

7. The system of claim 1, the instructions further causing the multiple technology credential reader to:
discover a second device associated with the first credential type within the radio frequency range of the first credential radio;
determine a second access timer has elapsed, the second access timer elapsing indicating the second device has not been positioned within the close proximity threshold range of the multiple technology credential reader; and
cause the second credential radio to exit the low power mode and poll for the second credential type.

8. The system of claim 1, the instructions further causing, responsive to discovering the first device, the first credential radio to reduce an access polling time interval associated with authorizing the credential access.

9. (canceled)

10. (canceled)

11. The system of claim 1, wherein:
the first credential type includes a Bluetooth low energy device; and
the second credential type includes a passive radio frequency access device.

12. (canceled)

13. (canceled)

14. The system of claim 1, wherein the credential access includes at least one of a physical access and a logical access.

15. A method for adaptive power saving for a multiple technology credential reader, the method comprising:
polling for a first credential type using a first credential radio, the first credential radio among a plurality of credential radios coupled to a multiple technology credential reader;
discovering a first device associated with the first credential type within a radio frequency range of the first credential radio;
causing, responsive to discovering the first device, a second credential radio associated with a second credential type to enter a low power mode;
determining the first device is positioned within a close proximity threshold range of the multiple technology credential reader; and
authorizing a credential access for the first device responsive to determining the first device is positioned within the close proximity threshold range.

16. (canceled)

17. The method of claim 15, wherein the low power mode includes causing the second credential radio to refrain from polling for the second credential type.

18. The method of claim 15, wherein the low power mode includes turning off all of the plurality of credential radios except for the first credential radio.

19. (canceled)

20. The method of claim 15, further including causing, subsequent to authorizing the credential access for the first device, the second credential radio to exit the low power mode and poll for the second credential type.

21. The method of claim 15, further including:
discovering a second device associated with the first credential type within the radio frequency range of the first credential radio;
determining a second access timer has elapsed, the second access timer elapsing indicating the second device has not been positioned within the close proximity threshold range of the multiple technology credential reader; and
causing the second credential radio to exit the low power mode and poll for the second credential type.

22. The method of claim 15, further including, responsive to discovering the first device, reducing an access polling time interval associated with authorizing the credential access.

23. (canceled)

24. (canceled)

25. The method of claim 15, wherein:
the first credential type includes a Bluetooth low energy device; and
the second credential type includes a passive radio frequency access device.

26. (canceled)

27. (canceled)

28. The method of claim 15, wherein the credential access includes at least one of a physical access and a logical access.

29-58. (canceled)

59. A non-transitory machine-readable storage medium, comprising instructions that, responsive to being executed with processor circuitry of a computer-controlled device, cause the processor circuitry to:
poll for a first credential type using a first credential radio, the first credential radio among a plurality of credential radios coupled to a multiple technology credential reader;
discover a first device associated with the first credential type within a radio frequency range of the first credential radio;
cause, responsive to discovering the first device, a second credential radio associated with a second credential type to enter a low power mode;
determine the first device is positioned within a close proximity threshold range of the multiple technology credential reader; and
authorize a credential access for the first device responsive to determining the first device is positioned within the close proximity threshold range.

60. The non-transitory machine-readable storage medium of claim 59, wherein the low power mode includes causing the second credential radio to refrain from polling for the second credential type.

61. The non-transitory machine-readable storage medium of claim 59, the instructions further causing the processor circuitry to cause, subsequent to authorizing the credential access for the first device, the second credential radio to exit the low power mode and poll for the second credential type.

62. The non-transitory machine-readable storage medium of claim 59, the instructions further causing the processor circuitry to:
discover a second device associated with the first credential type within the radio frequency range of the first credential radio;
determine a second access timer has elapsed, the second access timer elapsing indicating the second device has not been positioned within the close proximity threshold range of the multiple technology credential reader; and
cause the second credential radio to exit the low power mode and poll for the second credential type.
